(19) United States
(12) Patent Application Publication
(10) Pub. No.: US 2025/0308775 A1
(43) Pub. Date: Oct. 2, 2025

(54) MULTILAYER CERAMIC ELECTRONIC COMPONENT

(71) Applicant: TAIYO YUDEN CO., LTD., Tokyo (JP)

(72) Inventor: Kana TAMURA, Takasaki-shi (JP)

(21) Appl. No.: 19/075,395

(22) Filed: Mar. 10, 2025

(30) Foreign Application Priority Data
Mar. 26, 2024 (JP) 2024-048932

(51) Int. Cl. H01G 4/008; H01G 4/12; H01G 4/232; H01G 4/30

(52) U.S. Cl. CPC H01G 4/008; H01G 4/12; H01G 4/232; H01G 4/30

(57) ABSTRACT

A multilayer ceramic electronic component includes: a plurality of dielectric layers laminated along a first axis; a plurality of internal electrode layers each positioned between adjacent dielectric layers in the first axis of the plurality of dielectric layers; and intermediate regions positioned between the dielectric layers and the internal electrode layers, respectively. The internal electrode layers contain a nickel-copper alloy. The intermediate region contains copper. The concentration of the copper in each intermediate region varies in a thickness direction and has a peak at 2at % or greater and 10at % or less. The intermediate regions partially contain NiO layers at boundaries with the internal electrode layers. The total area of the NiO layers relative to the total area of the internal electrode layers is 1% or greater and 3.5% or less as measured on a cross-section of the multilayer ceramic electronic component along the first axis.

### CROSS-REFERENCE TO RELATED APPLICATION

The present application claims priority under 35 U.S.C. § 119 to Japanese Patent Application No. 2024-048932, filed Mar. 26, 2024, the contents of which are incorporated herein by reference in their entireties.

### BACKGROUND OF THE INVENTION

### Field of the Invention

The present disclosure relates to a multilayer ceramic electronic component.

### Description of the Related Art

In high-frequency communication systems, such as mobile phones, multilayer ceramic capacitors are used to eliminate noise. In electronic circuits that are related to human life, such as vehicle-mounted electronic controllers, multilayer ceramic capacitors are also used as well, and higher reliability than ever is required.

For example, in order to provide a nickel powder suitable for internal electrodes of multilayer ceramic capacitors and an efficient method for producing the nickel powder, a method of treating a raw nickel powder with a sulfur compound in a wet manner and then drying the resulting product, to produce a nickel powder containing a major part of sulfur in the form of a sulfide is disclosed (see, for example, Japanese Patent Application Laid-Open Publication No. 2010-043339).

According to the production method disclosed in Japanese Patent Application Laid-Open Publication No. 2010-043339, it is possible to obtain internal electrodes of a multilayer ceramic capacitor through improvement of sinterability by increasing the sintering-shrinkage start temperature of a powder, and through restriction of catalytic activity for excellent debindability.

### SUMMARY OF THE INVENTION

In a typical production method of multilayer ceramic capacitors, decomposition of an organic binder rapidly progresses due to catalytic action of nickel and nickel minute particles in debinding treatment of a laminate. This leads to generation of a large amount of gas, which may result in stacking faults such as delamination between a dielectric layer and an internal electrode layer, and breakage and cracks between the dielectric layer and the internal electrode layer.

In order to suppress such stacking faults, related art including the aforementioned Japanese Patent Application Laid-Open Publication No. 2010-043339 proposes a method of reducing the catalytic activity on a nickel surface by attaching sulfur to a surface of nickel minute particles to prevent rapid progression of decomposition of an organic binder in debinding treatment. However, when a minute nickel powder having a particle diameter of less than 0.20 μm and having an extremely high surface activity is used, there is a concern that the aforementioned technique of attaching sulfur alone cannot sufficiently reduce the surface activity. In addition, in the case of reducing the surface activity only by attaching sulfur, the content of sulfur becomes relatively high, and there is a concern of corrosion by sulfur.

Therefore, an object of the present disclosure is to provide a multilayer ceramic electronic component having a high strength and a long service life.

According to an embodiment in the present disclosure, a multilayer ceramic electronic component includes:
a plurality of dielectric layers laminated along a first axis;
a plurality of internal electrode layers each positioned between adjacent dielectric layers in the first axis of the plurality of dielectric layers; and
intermediate regions positioned between the dielectric layers and the internal electrode layers, respectively,
wherein the internal electrode layers contain a nickel-copper alloy,
the intermediate regions contain copper,
a concentration of the copper in each intermediate region varies in a thickness direction and has a peak at 2 at % or greater and 10 at % or less,
the intermediate regions partially contain NiO layers at boundaries with the internal electrode layers, and
a total area of the NiO layers relative to a total area of the internal electrode layers is 1% or greater and 3.5% or less as measured on a cross-section of the multilayer ceramic electronic component along the first axis.

According to the present disclosure, a multilayer ceramic electronic component having a high strength and a long service life can be provided.

### BRIEF DESCRIPTION OF THE DRAWINGS

FIG. 1 is a partially cross-sectioned oblique view illustrating a multilayer ceramic capacitor according to an embodiment in the present disclosure;

FIG. 2 is a cross-sectional view illustrating a multilayer ceramic capacitor according to an embodiment in the present disclosure;

FIG. 3 is a cross-sectional view illustrating a multilayer ceramic capacitor according to an embodiment in the present disclosure;

FIG. 4 is an enlarged view of a part of dielectric layers and internal electrode layers;

FIG. 5 is a schematic view of an image of an AA cross-section of FIG. 1 observed with a laser microscope;

FIG. 6A shows an example of a scanning line for a line analysis based on mapping data obtained by TEM-EDS;

FIG. 6B shows an example of a result of the line analysis;

FIG. 7 shows a graph for explaining an intermediate region;

FIG. 8 is a flowchart of a method for producing a multilayer ceramic capacitor according to an embodiment in the present disclosure;

FIG. 9A is a diagram illustrating a method for producing a multilayer ceramic capacitor according to an embodiment in the present disclosure; and

FIG. 9B is a diagram illustrating a method for producing a multilayer ceramic capacitor according to an embodiment in the present disclosure.

### DETAILED DESCRIPTION OF THE DISCLOSURE

### (Multilayer Ceramic Electronic Component)

A multilayer ceramic electronic component in the present disclosure has a plurality of dielectric layers laminated along a first axis, a plurality of internal electrode layers positioned between those of the dielectric layers that adjoin each other along the first axis, intermediate regions positioned between the dielectric layers and the internal electrode layers, and may have other members as necessary.

Embodiments in the present disclosure will now be described in detail, but the present disclosure is not limited to these embodiments.

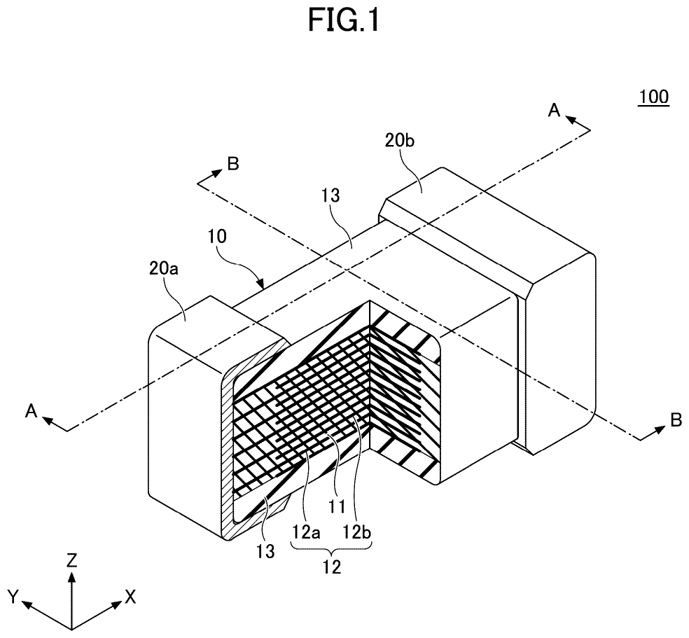

In the present specification and drawings, components having substantially the same functional configuration may be omitted from repeated descriptions by assigning the same reference numerals. Further, in the drawings, mutually orthogonal X, Y, and Z axes are indicated where appropriate. The X, Y, and Z axes define a fixed coordinate system that is fixed to a multilayer ceramic capacitor, which is an example of the multilayer ceramic electronic component. When a multilayer ceramic capacitor, which is an example of the multilayer ceramic electronic component, is formed in a roughly rectangular parallelepiped shape, the X, Y, and Z axes correspond to the length, width, and height of the roughly rectangular parallelepiped shape. The multilayer ceramic electronic component of this embodiment will be described below using a multilayer ceramic capacitor, which is an example of the multilayer ceramic electronic component.

[FIGS. 1 to 3]

FIG. 1 is a partially cross-sectioned oblique view illustrating a multilayer ceramic capacitor 100.

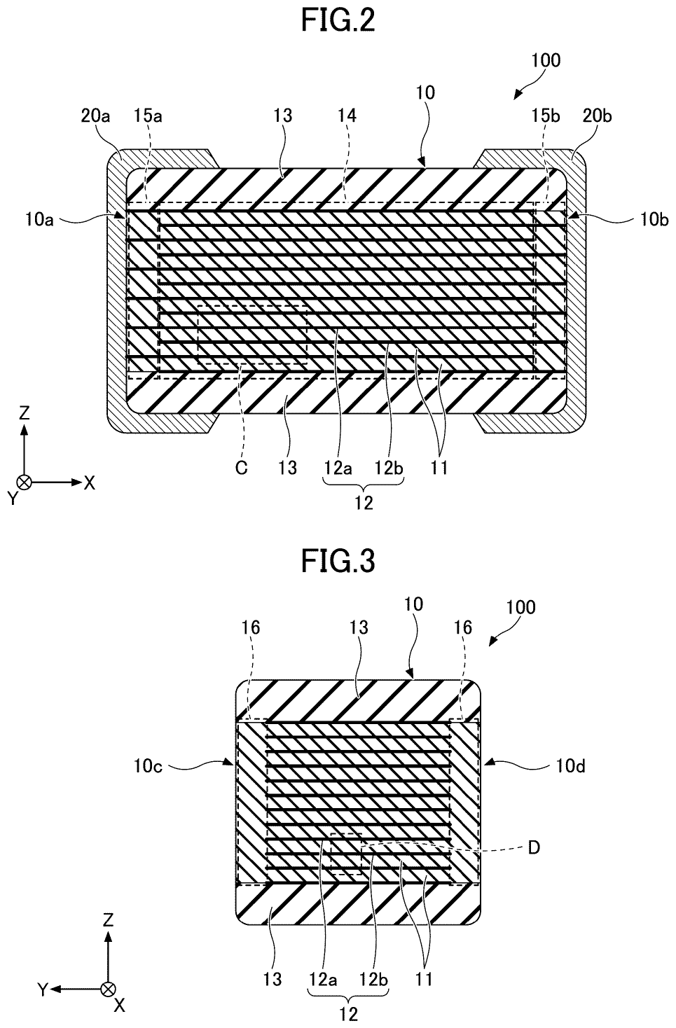

FIG. 2 is a cross-sectional view illustrating the multilayer ceramic capacitor, which is a cross-sectional view taken along line A-A in FIG. 1.

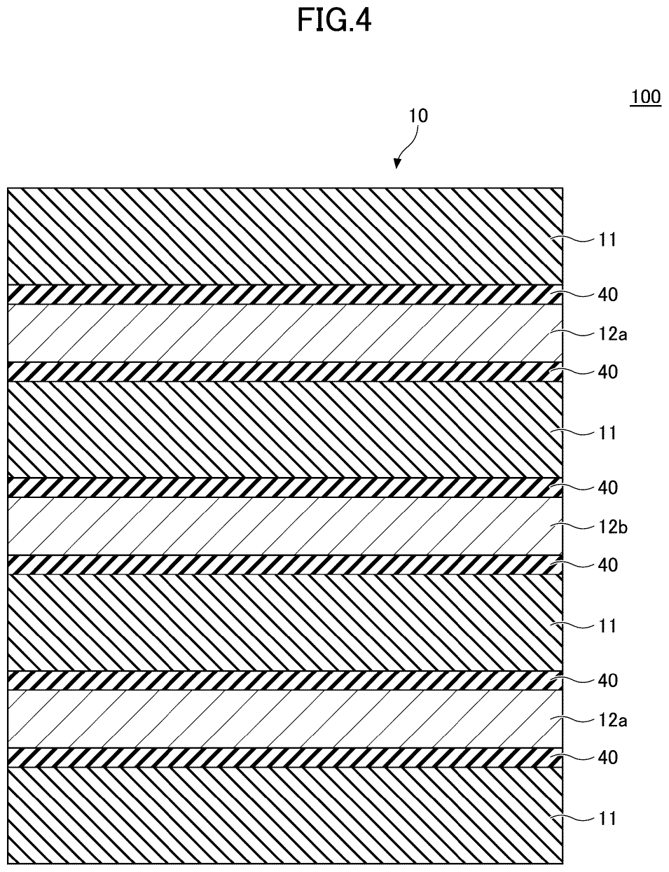

FIG. 3 is a cross-sectional view illustrating the multilayer ceramic capacitor, which is a cross-sectional view taken along line B-B in FIG. 1.

As illustrated in FIGS. 1 to 3, the multilayer ceramic capacitor 100 includes an element body 10 having a substantially rectangular parallelepiped shape. Two surfaces of the element body 10, among surfaces thereof, that face each other are referred to as an upper surface and a lower surface, and four surfaces connecting the upper surface and the lower surface are referred to as side surfaces. Normally, a surface of a multilayer ceramic capacitor that is on a circuit board side is referred to as a lower surface, when mounting the capacitor on a circuit board. However, this does not apply to other embodiments.

In the examples shown in FIGS. 1 to 3, in the element body 10, a first external electrode 20a and a second external electrode 20b are provided on a first side surface 10a and a second side surface 10b (see FIG. 2), which are two side surfaces facing each other.

The first external electrode 20a extends from the first side surface 10a to four adjacent surfaces. The second external electrode 20b extends from the second side surface 10b to four adjacent surfaces. However, the first external electrode 20a and the second external electrode 20b are spaced apart from each other.

The external electrodes may be provided on anywhere other than the two facing side surfaces, as long as it is on a surface of the element body 10.

The lamination direction in which dielectric layers 11 and internal electrode layers 12 are laminated is a first axis. In FIGS. 1 to 3, the first axis, which is the lamination direction of the dielectric layers 11 and the internal electrode layers 12, is the Z axis and is a direction in which the internal electrode layers face each other.

The axis perpendicular to the first axis, which is the lamination direction, is a second axis. In FIGS. 1 to 3, the second axis, which is the axis perpendicular to the first axis, which is the lamination direction, is the X-axis. The second axis is along the length direction of the element body 10, and is along the direction in which the first side surface 10a and the second side surface 10b of the element body 10 face each other, or along the direction in which the first external electrode 20a and the second external electrode 20b face each other.

The axis that is perpendicular to the first axis, which is the lamination direction, and that is also perpendicular to the second axis is a third axis. The third axis is along the width of the internal electrode layers 12. The third axis is along the direction in which a third side surface 10c and a fourth side surface 10d, which are two side surfaces of the element body 10 other than the first side surface 10a and the second side surface 10b, face each other (see FIG. 3). The X axis, the Y axis, and the Z axis are mutually orthogonal to each other.

The lamination direction is not limited to the Z direction, and can be any direction. For example, the first axis, which is the lamination direction, may be the X axis in the X direction or the Y axis in the Y direction.

In this specification, the contents described based on the coordinate system used in one embodiment are applicable to general embodiments by reading the coordinate system of the one embodiment as a general coordinate system in which the lamination direction is the first axis. For example, those that are used in FIGS. 1 to 3 relating to the one specific embodiment in which the lamination direction coincides with the Z direction and that are described as the X axis, the Y axis, and the Z axis can be read as the second axis, the third axis, and the first axis in general embodiments.

The element body 10 has a configuration in which the dielectric layers 11 containing a ceramic material functioning as a dielectric material and the internal electrode layers 12 are laminated alternately. The direction in which the dielectric layers 11 and the internal electrode layers 12 are laminated alternately is, for example, the vertical direction in FIGS. 1 to 3.

The internal electrode layers 12 include a plurality of first internal electrode layers 12a and a plurality of second internal electrode layers 12b. The first internal electrode layers 12a and the second internal electrode layers 12b are laminated alternately.

The edges of the first internal electrode layers 12a are extracted to a surface of the element body 10 on which the first external electrode 20a is provided, which is the first side surface 10a in the example of FIGS. 1 to 3. The edges of the second internal electrode layers 12b are extracted to a surface of the element body 10 on which the second external electrode 20b is provided, which is the second side surface 10b in the example of FIGS. 1 to 3. Thus, the first internal electrode layers 12a and the second internal electrode layers 12b are alternately connected electrically to the first external electrode 20a and the second external electrode 20b. Therefore, the multilayer ceramic capacitor 100 has a configuration in which capacitor units are laminated.

In the laminate of the dielectric layers 11 and the internal electrode layers 12, internal electrode layers 12 are positioned on the outermost layers in the lamination direction, and the outer surfaces of the laminate in the lamination direction, which are the upper surface and the lower surface in the example of FIGS. 1 to 3 are covered by a cover layer 13.

The cover layer 13 is mainly made of a ceramic material. For example, the cover layer 13 may have a composition that is the same as or different from the dielectric layers 11. Embodiments are not limited to the configuration shown in FIGS. 1 to 3 as long as the first internal electrode layers 12a and the second internal electrode layers 12b are exposed to different regions among the surfaces of the laminate and are in electrical conduction with different external electrodes. The different regions among the surfaces of the laminate may be surface regions included in facing surfaces of the laminate, respectively, may be surface regions included in adjacent surfaces of the laminate, respectively, or may be different surface regions included the same surface of the laminate. As long as the different external electrodes are spaced apart from each other, the external electrodes may extend from the surfaces of the laminate, which include the surface regions to which the first internal electrode layers 12a and the second internal electrode layers 12b are exposed, to any other surface.

Although details will be discussed later, the element body 10 includes a plurality of intermediate regions 40 (see FIG. 4) between the dielectric layers 11 and the internal electrode layers 12. In FIGS. 1 to 3, description of the intermediate regions 40 is omitted.

The size of the multilayer ceramic capacitor 100 is not particularly limited and can be appropriately selected according to the purpose. For example, the length may be 0.25 mm, the width may be 0.125 mm, and the height may be 0.125 mm. The length may be 0.4 mm, the width may be 0.2 mm, and the height may be 0.2 mm. The length may be 0.6 mm, the width may be 0.3 mm, and the height may be 0.3 mm. The length may be 1.0 mm, the width may be 0.5 mm, and the height may be 0.5 mm. The length may be 3.2 mm, the width may be 1.6 mm, and the height may be 1.6 mm. The length may be 4.5 mm, the width may be 3.2 mm, and the height may be 2.5 mm.

The above listed sizes of the multilayer ceramic capacitor 100 are only examples, and the multilayer ceramic capacitor is not limited to the sizes listed above.

The sizes of the multilayer ceramic capacitor 100 may be in the relationship of, for example, length>width≥height, width>length≥height, height>length≥width, or height>width≥length.

For example, the length represents the size in the X axis direction, the width represents the size in the Y axis direction, and the height represents the size in the Z axis direction.

### <Dielectric Layer>

The dielectric layer 11 is not particularly limited, can be selected appropriately according to the purpose, and may include, for example, a ceramic material having a perovskite structure represented by a general formula ABO₃ as the main phase. The perovskite structure contains ABO_{3-α}, which is deviated from the stoichiometric composition, (where 0≤α≤1: α represents the amount of deviation from the stoichiometric composition: a is hereinafter omitted from notation).

The ceramic material is not particularly limited and can be selected appropriately according to the purpose. Examples include barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr₂O₃ (where 0≤x≤1, 0≤y≤1, 0≤z≤1) that forms a perovskite structure, and the like.

Examples of the Ba_{1-x-y}CaₓSr_{y}Ti_{1-z}Zr₂O₃ include barium strontium titanate, barium calcium titanate, barium zirconate, barium zirconate titanate, calcium zirconate titanate, and barium calcium zirconate titanate.

The content of ceramic materials in the dielectric layer 11 is not particularly limited, can be appropriately selected according to the purpose, and is preferably 50 at % or greater, and may be, for example, 90 at % or greater.

Additives may be added to the dielectric layer 11.

Additives to the dielectric layer 11 are not particularly limited and can be appropriately selected according to the purpose. Examples include oxides of zirconium (Zr), magnesium (Mg), manganese (Mn), molybdenum (Mo), vanadium (V), chromium (Cr), rare earth elements (Scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)), or oxides containing cobalt (Co), nickel (Ni), lithium (Li), boron (B), sodium (Na), potassium (K), or silicon (Si), or glass containing cobalt, nickel, lithium, boron, sodium, potassium, or silicon, and the like.

### <Internal Electrode Layer>

The main component of the first internal electrode layers 12a and the second internal electrode layers 12b is a nickel-copper alloy.

The term “main component” in this specification means that the component is contained the most in terms of the number of moles among the components contained.

When nickel-copper alloy is included in each internal electrode layer, compared with when nickel is the main component of each internal electrode layer and copper is not included, an NiO layer (which is a general term including a single NiO layer and multiple NiO layers depending on the context) provided on the internal electrode layer in the intermediate region can be prevented from being formed more than the required amount. An NiO layer provided on the internal electrode layer in the intermediate region is fired under a weak reducing atmosphere so that NiO would not be reduced, whereas when firing is performed under the weak reducing atmosphere, Ni contained in each internal electrode may be oxidized and NiO may be newly formed. In this case, the NiO layer formed on the internal electrode layer may increase, and the desired NiO layer area (approximately 1% or greater and 3.5% or less the total area of the internal electrode layer) might not be obtained. Since copper is more difficult to oxidize than nickel, when a nickel-copper alloy, which is an alloy of copper and nickel, is contained in each internal electrode layer, the total NiO layer area relative to the total internal electrode layer area can be maintained even when firing is performed under the weak reducing atmosphere.

It is preferable that the nickel-copper alloy contains 0.2 at % or greater and 5 at % or less of copper from the viewpoint of inhibiting oxidation of nickel in the internal electrode layer.

The average thickness of the internal electrode layer is not particularly limited and can be appropriately selected according to the purpose. For example, it may be 0.4 μm or greater, but preferably 0.8 μm or greater in consideration of the thickness of the NiO layer.

As illustrated in FIG. 2, a region where the first internal electrode layers 12a connected to the first external electrode 20a and the second internal electrode layers 12b connected to the second external electrode 20b face each other is a region where electrical capacitance is generated in the multilayer ceramic capacitor 100. Therefore, the region where electrical capacitance is generated is referred to as the capacitive part 14. That is, the capacitive part 14 is a region where the internal electrode layers connected to different external electrodes and adjacent to each other across the dielectric layers face each other in the lamination direction.

A region where the first internal electrode layers 12a connected to the first external electrode 20a face each other in the lamination direction via no second internal electrode layers 12b connected to the second external electrode 20b is referred to as a first end margin 15a. A region where the second internal electrode layers 12b connected to the second external electrode 20b face each other in the lamination direction via no first internal electrode layers 12a connected to the first external electrode 20a is referred to as a second end margin 15b.

Each end margin is a region in which internal electrode layers connected to the same external electrode face each other in the lamination direction via no internal electrode layers that are connected to a different external electrode. The first end margin 15a and the second end margin 15b are regions in which no electric capacitance is generated.

Side margins 16 are regions provided on the outer side of the capacitive part 14 in the third direction that is perpendicular to the lamination direction and is perpendicular to the second direction, which is the Y-axis direction in the example of FIG. 3. That is, the side margins 16 are outer regions adjacent to the capacitive part 14 when viewed in the lamination direction, and are outer regions adjacent to the capacitive part 14 on the sides to which the internal electrode layers are not extracted. The side margins 16 are also regions in which no electric capacitance is generated.

### <Intermediate Region>

FIG. 4 shows an enlarged view of a part of the dielectric layers and the internal electrode layers, which is an enlarged view of, for example, the region D in FIG. 3.

The multilayer ceramic capacitor 100 includes intermediate regions 40 between the internal electrode layers 12 and the dielectric layers 11. Since FIG. 4 is a schematic diagram, the intermediate regions 40 are each illustrated as a continuous layer having a constant thickness. However, this configuration does not apply to other embodiments. The intermediate regions 40 may be, for example, discontinuous and have a different thickness depending on the location.

To determine the presence or absence of the intermediate regions 40, the multilayer ceramic capacitor 100 is polished to the center along the Y-axis, to prepare a sample in which an XZ face in which the dielectric layers 11 and the internal electrode layers 12 are laminated is exposed, as shown in FIGS. 1 and 2. The presence or absence of the intermediate regions 40 can be confirmed by generating a line profile of the sample by energy dispersive X-ray spectroscopy using a transmission electron microscope (TEM-EDS analysis). The TEM-EDS analysis will be described later.

### <<NiO Layer>>

The intermediate region partially includes NiO layers on the internal electrode layer. In this specification, “partially including NiO layers” means that the NiO layers are discontinuously provided on the internal electrode layer.

By partially providing NiO layers on the internal electrode layer, it is possible to overcome problems such as deterioration of electrical properties such as reduction in the capacitance and the like, due to reduction in the effective intersecting area (overlapping area) of the internal electrode layers.

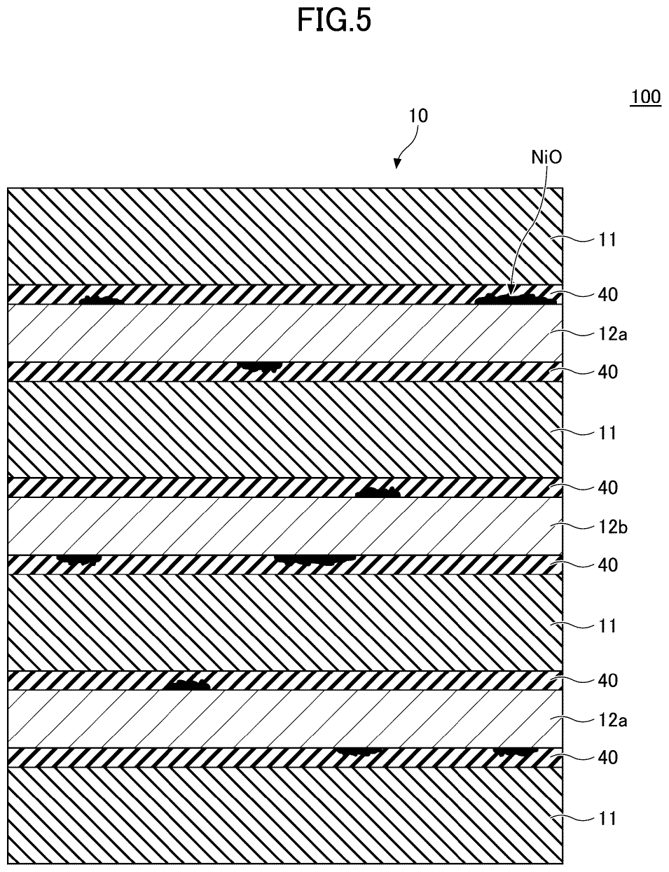

NiO layers formed on the internal electrode layer will now be described with reference to FIG. 5. FIG. 5 is a schematic view of an image of an AA cross-section of FIG. 1 observed with a laser microscope.

In FIG. 5, NiO layers are partially formed on the internal electrode layers 12a and 12b in the intermediate region 40.

When NiO layers are partially provided on the internal electrode layer in the intermediate region, the NiO layers serve as a supply source of oxygen during the debinding treatment at 100° C. to 700° C. Therefore, the debindability in the multilayer ceramic electronic component can be improved and residual carbon can be reduced. In particular, the debindability in the internal electrode layer can be improved and residual carbon can be reduced. As a result, when the dielectric layer grain-grows at 1,000° C. to 1,100° C., the dielectric layer is inhibited from grain-growing more than necessary due to the interior of the multilayer ceramic electronic component being strongly reduced by residual carbon. This suppresses the occurrence of cracks in the multilayer ceramic electronic component caused by sinterability difference between dielectric layers on the inner side close to the internal electrode and dielectric layers on the outer peripheral region apart from the internal electrode due to greater grain growth of the inner side dielectric layers than that of the outer peripheral dielectric layers, and caused by gas that may be generated by thermal decomposition of residual carbon.

When NiO layers are partially provided on the internal electrode layer in the intermediate region, generation of voids in the internal electrode layer can be inhibited. There is a difference in sintering shrinkage behavior between the internal electrode layer containing nickel-copper alloy and the dielectric layer composed of a ceramic material such as BaTiO₃. That is, voids may be generated in the internal electrode layer because the internal electrode layer is sintered first and spheroidized. Such voids may cause a decrease in adhesion between the dielectric layer and the internal electrode layer and in moisture resistance, potentially leading to problems such as delamination.

Therefore, by providing NiO layers partially on the internal electrode layer in the intermediate region, it is possible to match the sintering shrinkage strength of the internal electrode layer with that of the dielectric layer. As a result, thermal shrinkage difference between the internal electrode layer and the dielectric layer is reduced, and generation of voids in the internal electrode layer can be inhibited. The mechanism behind this is considered as follows. When the internal electrode layer is sintered, the nickel-copper alloy existing in a region on which no NiO layer is provided becomes a liquid phase and spheroidizes, while the NiO layer is maintained in a solid phase. Therefore, the spheroidized nickel-copper alloy is pushed by the NiO layer, and generation of voids is inhibited.

The total area of NiO layers relative to the total area of the internal electrode layers in a cross-section of the multilayer ceramic electronic component is 1% or greater and 3.5% or less.

When the total area of the NiO layers is 1% or greater, it is possible to sufficiently achieve the above-mentioned debindability and the effect of inhibiting generation of voids.

When the total area of NiO layers is 3.5% or less, it is possible to overcome problems such as deterioration of electrical properties such as reduction in the capacitance and the like due to reduction in the effective intersecting area of the internal electrode layers.

It should be noted that the cross-section of the multilayer ceramic electronic component may be a cross-section including the first axis that is the lamination direction, and may be, for example, an AA cross-section indicated in FIG. 1.

The method of forming NiO layers on the internal electrode layer in the intermediate region is not particularly limited and can be selected appropriately according to the purpose. An example of the method is a method of providing a mask having openings on an internal electrode sheet, vapor-depositing a liquid composition for forming NiO layers, and then firing it in a weak reducing atmosphere, to thereby form NiO layers.

The shape of the openings of the mask is not particularly limited and can be selected appropriately according to the purpose. Examples of the shape include a circular shape, an elliptical shape, a rectangular shape, and the like.

The diameter of the openings is not particularly limited and can be selected appropriately according to the purpose, and may be, for example, 5 μm or greater and 20 μm or less.

The interval at which the openings are provided is not particularly limited and can be selected appropriately according to the purpose, and may be, for example, 50 μm or greater and 100 μm or less.

It is preferable that the intermediate region contains copper, and preferably a copper-segregated layer obtained from copper being segregated on the internal electrode layer.

When a small amount of a metal element is contained in the intermediate region, the height of an electrical barrier (Schottky barrier) between the dielectric layer and the internal electrode layer is increased, and therefore the high-temperature load service life is improved better than in a structure in which the dielectric layer and the internal electrode layer are in direct contact. The high-temperature load service life is not affected by the concentration of a metal element in the internal electrode layer, but varies depending on the concentration of the metal element in the intermediate region between the dielectric layer and the internal electrode layer. That is, when the concentration of the metal element in the intermediate region is higher than the concentration of a metal element in the internal electrode layer, the height of the electrical barrier (Schottky barrier) between the dielectric layer and the internal electrode layer is increased, to inhibit rise in a leakage current during a measurement under a high-temperature load, and improve the service life. In the present disclosure, the service life is improved by formation of a copper-segregated layer on the internal electrode layer in the intermediate region.

The state of copper in the intermediate region 40 is not particularly limited. In the intermediate region 40, copper may form a compound with any other element.

It is possible to form the copper-segregated layer in the intermediate region by increasing the temperature raising rate (to, for example, 15,000° C./h) during firing when densifying the multilayer ceramic electronic component. Although the details of the mechanism behind copper-segregated layer formation in the intermediate region are yet to be elucidated, it is considered that the nickel-copper alloy contained in the internal electrode layer and having a higher melting point than that of copper solidifies earlier than copper, and firing performed at a high temperature raising rate cannot allow thermal equilibrium to be reached sufficiently, to not allow the entirety of added copper to alloy with nickel completely, so copper is pushed out into the intermediate region to form the copper-segregated layer.

The concentration of copper in the intermediate region is not particularly limited and can be appropriately selected according to the purpose, and it is preferable that the concentration of copper has a peak at 2 at % or greater and 10 at % or less from the viewpoint of obtaining a good service life improvement effect.

In the intermediate region, it is preferable that the copper-segregated layer exists only on the internal electrode layer in the intermediate region and does not on the NiO layer. In other words, it is preferable that the copper-segregated layer and the NiO layer exist mutually exclusively on the internal electrode layer in the intermediate region. In other words, it is preferable that the NiO layer is provided in a region where the copper-segregated layer is not provided on the internal electrode layer in the intermediate region. With this configuration, compared with a case where no NiO layer is provided on the internal electrode layer in the intermediate region, it is possible to restrict the addition amount of copper required to adjust the peak concentration of the copper-segregated layer to be provided on the internal electrode layer in the intermediate region to 2 at % or greater and 10 at % or less. Thus, the effect of copper on the dielectric layer during sintering can be reduced, and the dielectric constant can be prevented from decreasing.

The method for measuring the copper concentration in the intermediate region and the total area of the NiO layers is not particularly limited, and can be appropriately selected according to the purpose. Examples of the method are as follows.

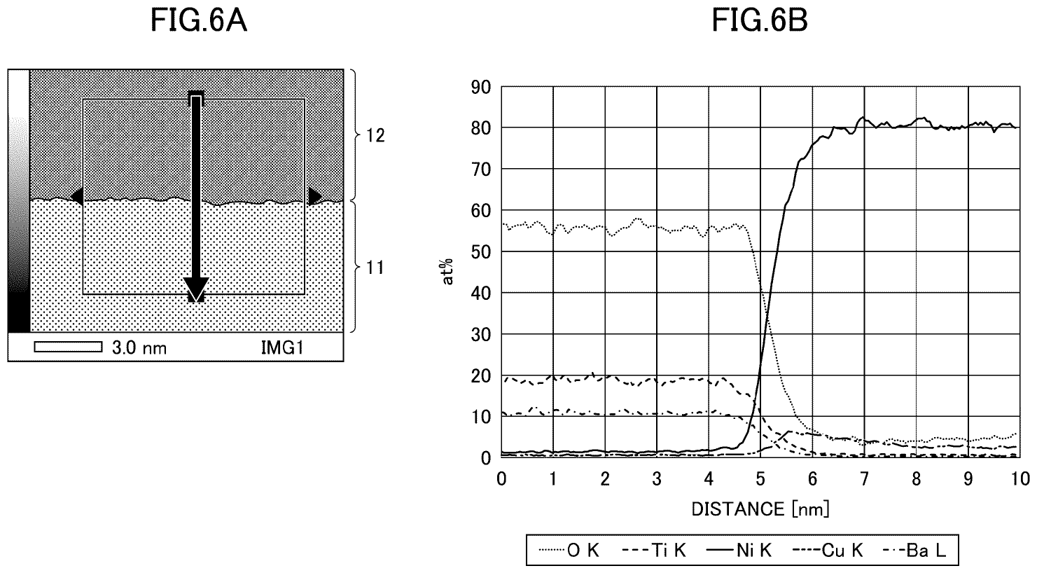

The copper concentration in the intermediate region is quantitatively determined by a line analysis using Transmission Electron Microscope-Energy Dispersive X-ray Spectroscopy (TEM-EDS). The observation region is defined from the internal electrode layer to the dielectric layer in the AA cross-section indicated in FIG. 1. Furthermore, since no copper-segregated layer appears in the NiO layer parts in TEM-EDS, the observation region is defined to exclude the interface between the internal electrode layer and an NiO layer and the interface between an NiO layer and the dielectric layer. TEM-EDS mapping data of the observation region is measured, and a line analysis is performed based on the obtained mapping data. The scanning line is defined as a line extending from the internal electrode layer 12 to the dielectric layer 11 as indicated by the arrow in FIG. 6A. By reconstructing the mapping data of the quantification target elements, a line profile is created for each of the quantification target elements. The quantification target elements are Ba, Ti, and O, which are the main components of the dielectric layer, Ni, which is a component of the internal electrode layer, and Cu, which is segregated in the intermediate region. An example of the result is shown in FIG. 6B.

The total area of the NiO layers in the intermediate regions is observed by SEM-EDS of the AA cross-section indicated in FIG. 1 after the multilayer ceramic capacitor 100 is filled with a resin and mirror-polished. The total area of the NiO layers relative to the total area of the internal electrode layers is calculated according to (Total area of the NiO layers/Total area of the internal electrode layers)×100. At a SEM-EDS observation magnification of ×2,000, and at a field of view of the observation region of 40×60 μm, a region that is approximately the center of the internal electrode layers in the lamination direction, and is also approximately the center of the internal electrodes in the cross-sectional length is observed. The total area of the NiO layers is measured by regarding that a region in the EDS element map where the concentrations of both the element mapped image of the Ni element (K rays) and the element mapped image of the O element (K rays) are 10 at % or greater is an NiO layer region in which both Ni and O are present. The total area of the internal electrode layers is measured based on the regions in the EDS element map where the concentration of the element mapped image of the Ni element (K rays) of the internal electrode layers is 70 at % or greater and the concentration of the element mapped image of the O element (K rays) is less than 10 at %.

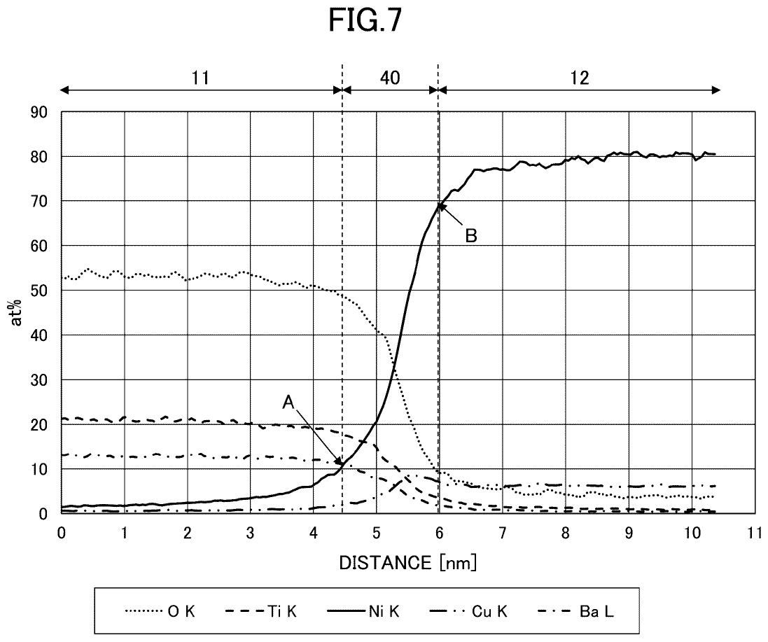

Here, as the intermediate region in the present disclosure, a range from the point A on the Ni concentration profile and the Ba concentration profile to the point B where the Ni concentration reaches 70 at % in the line profiles obtained by TEM-EDS, as shown in FIG. 7, is defined as the intermediate region 40.

As for the method of determining whether or not a copper-segregated layer is generated, the determination criterion is whether the maximum value of the Cu concentration in the intermediate region 40 is greater than the average of the Cu concentration measured values in the dielectric layer 11 region (2 nm from the interface between the intermediate region and the dielectric layer) and the average of the Cu concentration measured values in the internal electrode layer 12 (2 nm from the interface between the intermediate region and the internal electrode layer) in the line profiles.

### (Method of Producing Multilayer Ceramic Electronic Components)

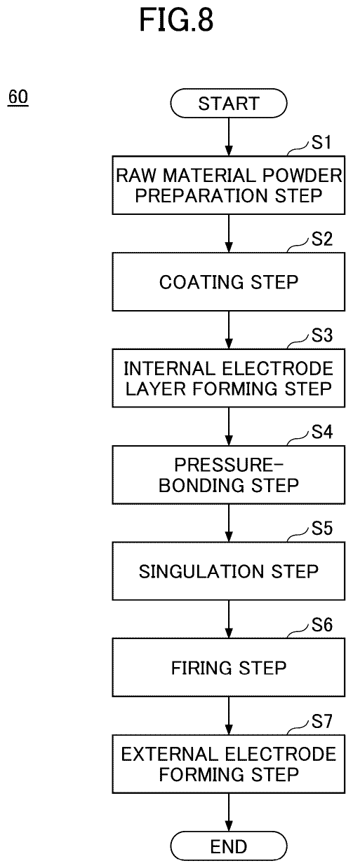

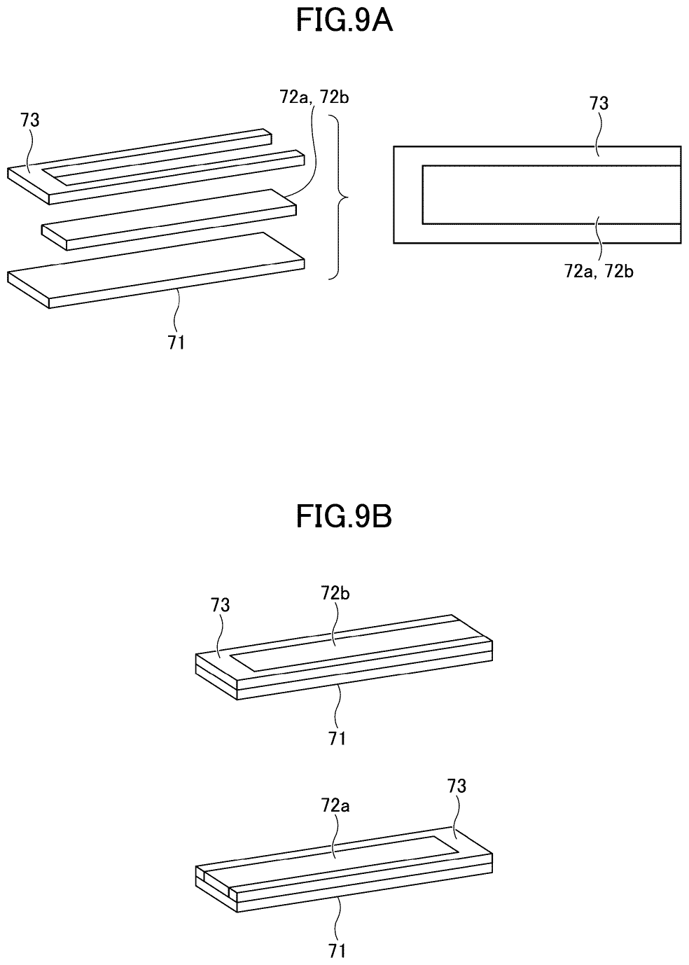

Next, a method of producing the multilayer ceramic capacitor 100 will be described. FIG. 8 is a flowchart 60 illustrating a method of producing the multilayer ceramic capacitor 100. FIG. 9 is a diagram illustrating a method of producing the multilayer ceramic capacitor 100.

### (1) Raw Material Powder Preparation Step (S1)

In the raw material powder preparation step, first, a dielectric material for forming the dielectric layer 11 is prepared. The A-site element and the B-site element contained in the dielectric layer 11 are typically contained in the dielectric layer 11 in the form of sintered particles of ABO_{3-α} (0≤α≤1). For example, barium titanate is a tetragonal crystal compound having a perovskite-type structure and exhibits a high relative dielectric constant. Typically, it is possible to obtain barium titanate by reacting a titanium raw material such as titanium dioxide or the like with a barium raw material such as barium carbonate or the like.

Various methods have been known as a method for synthesizing the main component ceramic of the dielectric layer 11, such as solid-phase methods, sol-gel methods, hydrothermal methods, and the like. In this embodiment, any of these methods can be adopted.

A predetermined additive compound is added to the obtained ceramic raw material powder according to the purpose. Examples of the additive compound include oxides of zirconium (Zr), magnesium (Mg), manganese (Mn), molybdenum (Mo), vanadium (V), chromium (Cr), rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb), or oxides containing cobalt (Co), nickel (Ni), lithium (Li), boron (B), sodium (Na), potassium (K), or silicon (Si), or glass containing cobalt, nickel, lithium, boron, sodium, potassium, or silicon, and the like.

For example, a ceramic material is prepared by mixing the ceramic raw material powder with a compound containing the additive compound by wet-mixing, and drying and pulverizing the resulting product. For example, as needed, the ceramic material obtained in the way described above may be subjected to a pulverizing treatment to adjust the particle diameter, or further to a classification treatment in combination to adjust the particle diameter.

Through the above step, the dielectric material is obtained.

### (2) Coating Step (S2)

Next, in the coating step, a binder such as polyvinyl butyral (PVB) resin, an organic solvent such as ethanol, toluene, or the like, and a plasticizer are added to the obtained raw material powder, such that they can be mixed by wet-mixing. In the raw material powder preparation step (S1), the binder and the like may be added in the mixing of the ceramic raw material powder and the like, such that they can be mixed by wet-mixing.

In the coating step, using the obtained slurry, a ceramic green sheet 71 can be applied to a substrate by, for example, a die coater method or a doctor blade method, and dried. The substrate is, for example, a polyethylene terephthalate (PET) film. A drawing for illustrating the coating step is omitted. The ceramic green sheet 71 is an example of a dielectric green sheet.

### (3) Internal Electrode Layer Forming Step (S3)

As described above, the main component of the first internal electrode layer 12a and the second internal electrode layer 12b is a nickel-copper alloy. The first internal electrode layer 12a and the second internal electrode layer 12b need only to contain a nickel-copper alloy after they are sintered, and a metal conductive paste as the raw material may contain not only a nickel-copper alloy, but also nickel or a nickel-containing alloy and copper as separate materials. It is preferable that the main component of the metal conductive paste is a nickel-copper alloy, considering the dispersibility of copper in nickel.

The metal conductive paste for forming the precursor of the first internal electrode layer 12a and the second internal electrode layer 12b can be prepared by kneading together the main component, an organic binder, and a solvent.

In the internal electrode layer forming step, as illustrated in FIG. 9A, the metal conductive paste for forming the internal electrode layer, containing an organic binder, can be printed on a surface of the ceramic green sheet 71 by screen printing, gravure printing, or the like. Thus, a first internal electrode layer pattern 72a for the first internal electrode layer 12a or a second internal electrode layer pattern 72b for the second internal electrode layer 12b is placed on the surface of the ceramic green sheet 71. Ceramic grains can be added to the metal conductive paste as a co-existent material. The main component of the ceramic grains is not particularly limited, but is preferably the same as the main component ceramic of the dielectric layer 11. When adding ceramic grains as a co-existent material, they can be added in the kneading of the metal conductive paste. The method for forming the internal electrode layer is not particularly limited, and plating, vacuum vapor deposition, sputtering, or CVD may be used.

Moreover, a dielectric pattern paste for a reverse pattern layer may be obtained by adding a binder such as ethyl cellulose or the like and an organic solvent such as terpineol or the like to the dielectric pattern material obtained in the raw material powder preparation step, and kneading them by a roll mill. Then, as illustrated in FIG. 9A, a dielectric pattern 73 may be placed on the ceramic green sheet 71 by printing the dielectric pattern paste on a peripheral region where no internal electrode layer pattern is printed, to fill the gap from the internal electrode layer pattern. The ceramic green sheet 71 on which the internal electrode layer patterns and the dielectric pattern 73 are printed is referred to as a lamination unit.

Then, as illustrated in FIG. 9B, the lamination units can be laminated such that the internal electrode layers and the dielectric layers are alternate and such that the edges of the internal electrode layers are exposed to the end surfaces of the dielectric layers on alternate sides in the length direction and extracted to alternate ones of a pair of external electrodes having different polarities (laminating step). Specifically, a ceramic green sheet 71 on which the first internal electrode layer pattern 72a and the dielectric pattern 73 are printed and a ceramic green sheet 71 on which the second internal electrode layer pattern 72b and the dielectric pattern 73 are printed are laminated in this order. For example, the number of lamination units to be laminated can be set to 100 to 500 layers.

### (4) Pressure-Bonding Step (S4)

In the pressure-bonding step, the laminate in which the lamination units are laminated can be thermally pressure-bonded, with a predetermined number of, for example, 2 to 10, of layers of cover sheets laminated on top and bottom of the laminate.

### (5) Singulation Step (S5)

In the singulation step, the pressure-bonded body obtained by the pressure-bonding can be singulated into individual pieces. Existing methods such as dicing by a dicer, laser cutting, and the like can be appropriately used as the method for singulation.

### (6) Firing Step (S6)

In the firing step, the laminates singulated into individual pieces are subjected to a debinding treatment and fired.

The conditions of the debinding treatment are not particularly limited, and the debinding treatment can be carried out, for example, at 300° C. to 600° C. for 4 hours to 12 hours under a nitrogen atmosphere.

The conditions of firing are not particularly limited, and firing can be carried out, for example, under a reducing atmosphere at an oxygen partial pressure of 10-10 atm or higher and 10⁻⁹ atm or lower in a temperature range of 1,100° C. or higher and 1, 350° C. or lower at a high temperature raising rate (of 10,000° C./h to 15,000° C./h) for 5 minutes or longer and 10 hours or shorter. The preferred temperature range is 1,150° C. or higher and 1,350° C. or lower.

### (7) External Electrode Forming Step (S7)

In the external electrode forming step, the first external electrode 20a and the second external electrode 20b can be formed by metal paste dipping and baking, and further plating or the like. The multilayer ceramic capacitor 100 is completed through the above steps.

The above steps are examples, and the method for producing the multilayer ceramic capacitor of the present embodiment is not limited to the above mode. For example, the external electrodes may be formed by sintering them, after the singulation step, in the firing step simultaneously with the firing of the dielectric parts.

### OTHER EMBODIMENTS

Although the embodiment has been described in detail, the present disclosure is not limited to the specific embodiment, and various modifications and changes are applicable within the scope of the claims.

The intermediate region can be formed as follows. That is, in the internal electrode layer forming step, a first intermediate region pattern is formed on a ceramic green sheet 71, an internal electrode region pattern is formed on the first intermediate region pattern, and a second intermediate region pattern is formed on the internal electrode region pattern. The first intermediate region pattern and the second intermediate region pattern are patterns of regions to become NiO layers in the intermediate region after being fired, and are formed so as to occupy part of the upper and lower surfaces of the internal electrode pattern region. It is preferable to form the first intermediate region pattern and the second intermediate region pattern by a sputtering method. In this way, a laminate including the ceramic green sheet 71, the first intermediate region pattern, the internal electrode layer pattern, and the second intermediate region pattern is prepared. In the firing step, the laminate is fired in a weak reducing atmosphere. In this way, the intermediate regions can be formed.

For example, the above-described embodiment is applied to a multilayer ceramic capacitor having two terminal electrodes, but may also be applied to a multilayer ceramic capacitor having three or more terminals.

In the above-described embodiment, a multilayer ceramic capacitor has been described as an example of the multilayer ceramic electronic component. However, the present disclosure is generally applicable to all types of multilayer ceramic electronic components. Examples of such multilayer ceramic electronic components include chip varistors, chip thermistors, and the like.

### EXAMPLES

The present disclosure will be specifically described below by way of Examples and Comparative Examples. However, the present disclosure is not limited to these Examples in any way. In the following Examples and Comparative Examples, “part” means “part by mass” and “%” means “% by mass” unless otherwise particularly noted.

### Example 1

A mask was set on an unfired barium titanate sheet having a thickness of 2 μm, a predetermined amount of NiO was vapor-deposited by sputtering, and then an internal electrode layer paste in which predetermined amounts of nickel and copper were mixed was printed. Further, a similar mask was set on the printed internal electrode layer pattern, and a predetermined amount of NiO was vapor-deposited by sputtering. NiO was vapor-deposited so that the average thickness of NiO layers resulting from sintering would be 300 nm or greater and 500 nm or less.

The mask used had a structure in which circular holes were opened at the positions coinciding with the internal electrode intersecting region so that NiO would be vapor-deposited on the internal electrode intersecting region. The diameter of the circular holes was 15 μm, and the interval between the holes was 80 μm.

Next, the sheets were laminated to produce a model chip as shown in FIG. 1. Firing was carried out at a high temperature raising rate (15,000° C./h) in a weak reducing atmosphere so that NiO would remain, to produce a multilayer ceramic electronic component of Example 1.

The obtained multilayer ceramic electronic component had the 1005 shape (1.0 mm in length×0.5 mm in width×0.5 mm in height), included eleven internal electrodes, and had an average layer thickness of 2 μm.

### [Copper Concentration Measurement]

The copper concentration in the intermediate region was determined by a line analysis with Transmission Electron Microscope-Energy Dispersive X-ray Spectroscopy (TEM-EDS). The observation region was from an internal electrode layer to a dielectric layer in the AA cross-section indicated in FIG. 1. Furthermore, since no copper-segregated layer would appear in NiO layer parts in the TEM-EDS, the observation region was defined to exclude the interface between the internal electrode layer and an NiO layer and the interface between an NiO layer and the dielectric layer. TEM-EDS mapping data of the observation region was measured, and a line analysis was performed based on the obtained mapping data. The scanning line was a line extending from the internal electrode layer 12 to the dielectric layer 11 as indicated by the arrow in FIG. 6A. By reconstructing the mapping data of the quantification target elements, a line profile of each quantification target element was generated. The quantification target elements were Ba, Ti, and O, which were the main components of the dielectric layer, Ni, which was a component of the internal electrode layer, and Cu segregated in the intermediate region. Using this line profile, the copper concentration in the intermediate region was determined. The results are indicated in Table 1.

### [Measurement of Area of NiO Layer]

After the multilayer ceramic capacitor 100 was filled with a resin and mirror-polished, the AA cross-section indicated in FIG. 1 was observed by SEM-EDS. At a SEM-EDS observation magnification of ×2,000, and at a field of view of the observation region of 40×60 μm, a region that was approximately the center in the internal electrode layer lamination direction and was approximately the center in the internal electrode cross-sectional length was observed.

The total area of the NiO layers relative to the total area of the internal electrode layers was calculated according to (Total area of the NiO layers/Total area of the internal electrode layers)×100. The total area of the NiO layers was measured by regarding that a region in the EDS element map where the densities of both the element mapped image of the Ni element (K rays) and the element mapped image of the O element (K rays) were 10 at % or greater was an NiO layer region in which both Ni and O were present. The total area of the internal electrode layers was measured based on the regions in the EDS element map where the concentration of the element mapped image of the Ni element (K rays) of the internal electrode layers was 70 at % or greater and the concentration of the element mapped image of the O element (K rays) was less than 10 at %. The results are shown in Table 1.

### [Crack Evaluation]

The chip was filled with a resin and polished so that a W-T cross-section could be observed, and whether there were cracks in the chip was confirmed. The total number of samples was ten. The crack evaluation is related to the debindability. The results are shown in Table 1.

### [HALT Test]

Fifty samples were prepared, and a voltage of 50 V/μm was applied to the samples in a thermostatic chamber at 125° C., and the time taken until insulation deterioration occurred was measured. The test result is the average value of these samples. The results are shown in Table 1.

### [Adhesion Evaluation]

After deforming a substrate-mounted sample by 3 mm perpendicularly to a surface of the sample mounted on the substrate, the chip was embedded in a resin, and a cross-section of the chip was polished. The presence or absence of interlayer fracture at the interface between the dielectric layer and the internal electrode layer was confirmed using an electron microscope. The total number of samples was ten. The results are shown in Table 1.

### [Judgment]

When the number of cracks was zero in the crack evaluation, the service life was 400 min or longer in the HALT test, and the number of interlayer fractures was zero in the adhesion evaluation, the grade was “A”. Otherwise, the grade was “B”. The results are shown in Table 1.

### Examples 2 to 8

Multilayer ceramic electronic components of Examples 2 to 8 were produced in the same manner as in Example 1 except that the copper concentration and the NiO layer area were changed as shown in Table 1, and evaluated in the same manner.

Regarding Example 3, the result of the TEM analysis of the AA cross-section indicated in FIG. 1 is shown in FIG. 6B.

### Comparative Example 1

A multilayer ceramic electronic component of Comparative Example 1 was produced in the same manner as in Example 1, except that no NiO layer was formed on the internal electrode layers, and firing was performed under a rather strongly reducing condition (2.7×10⁻⁹ atm) under which the internal electrode layers would be rarely oxidized, and evaluated in the same manner.

### Comparative Examples 2 to 9

Multilayer ceramic electronic components of Comparative Examples 2 to 9 were produced in the same manner as in Example 1 except that the copper concentration and the NiO layer area were changed as shown in Table 1, and evaluated in the same manner.

TABLE 1

| | | Ratio of | | | | |
|---|---|---|---|---|---|---|
| | | total NiO | | | | |
| | | layer area | | | | |
| | Peak | to total | | | | |
| | copper | intl. | | | | |
| | in interm. | electrode | Evaluation | | | |
| | region | layer area | Crack | Adhesion | HALT | Judge- |
| | [at %] | [%] | [number] | [number] | [min. ] | ment |
| Ex. 1 | 2 | 2.4 | 0 | 0 | 500 | A |
| Ex. 2 | 5.5 | 2.4 | 0 | 0 | 600 | A |
| Ex. 3 | 6.4 | 1.5 | 0 | 0 | 700 | A |
| Ex. 4 | 6.4 | 1.5 | 0 | 0 | 700 | A |
| Ex. 5 | 6.4 | 2.7 | 0 | 0 | 700 | A |
| Ex. 6 | 6.4 | 3.3 | 0 | 0 | 400 | A |
| Ex. 7 | 10 | 3.5 | 0 | 0 | 400 | A |
| Ex. 8 | 5.5 | 1 | 0 | 0 | 600 | A |
| Comp. | 0 | 0.8 | 10 | 10 | 200 | B |
| Ex. 1 | | | | | | |
| Comp. | 0 | 87 | 10 | 10 | 0 | B |
| Ex. 2 | | | | | | |
| Comp. | 6.4 | 0.7 | 3 | 10 | 600 | B |
| Ex. 3 | | | | | | |
| Comp. | 12 | 2.4 | 0 | 0 | 300 | B |
| Ex. 4 | | | | | | |
| Comp. | 6.4 | 4 | 0 | 0 | 300 | B |
| Ex. 5 | | | | | | |
| Comp. | 6.4 | 20 | 0 | 3 | 100 | B |
| Ex. 6 | | | | | | |
| Comp. | 5.5 | 4 | 0 | 0 | 200 | B |
| Ex. 7 | | | | | | |
| Comp. | 5.5 | 0.9 | 3 | 10 | 500 | B |
| Ex. 8 | | | | | | |
| Comp. | 1.6 | 2.4 | 0 | 0 | 300 | B |
| Ex. 9 | | | | | | |

In Examples 1 to 8, a predetermined amount of NiO layers formed on the internal electrode layers served as an intra-chip supply source of oxygen for the debinding treatment, and the number of cracks due to debinding insufficiency was zero. The presence of the NiO layers reduced voids in the internal electrode layers, so the adhesion at the interface between the dielectric layer and the internal electrode layer was improved, resulting in the number of interlayer fractures of 0. The HALT property was 400 min to 700 min, and the service life was improved through improvement of the Schottky barrier by addition of copper.

In Comparative Example 1, the main component of the internal electrode layer was Ni, and the effects of crack inhibition, adhesion, and service life improvement were not observed.

In Comparative Example 2, because Ni and Cu were not alloyed in the internal electrode layers, the internal electrode layers were oxidized as a whole and the NiO layer proportion reached 87%. Cracks and interlayer fractures were observed due to the expansion of the internal electrode layers, and the HALT test measurement could not be carried out due to short circuiting.

In Comparative Example 3, the HALT property was 600 min, which was high, owing to the presence of Cu-segregated layers in the intermediate regions, but the effects of crack inhibition and adhesion were not observed because substantially no or insignificant NiO layer was present.

In Comparative Example 4, the effect of service life improvement was not observed because the copper peak in the intermediate regions was high.

In Comparative Examples 5 and 7, the effect of service life improvement was not observed because the internal electrode continuation percentage was low due to a large total NiO layer area.

In Comparative Example 6, in which the total NiO layer area was large, adhesion at the interface between the dielectric layer and the internal electrode layer was poor due to the internal electrode layer expansion, and interlayer fractures occurred.

In Comparative Example 8, in which the total NiO layer area was small, the debindability and adhesion at the interface between the dielectric layer and the internal electrode layer were poor, and cracks and interlayer fracture were observed in some chips.

In Comparative Example 9, the effect of service life improvement was not observed because the height of the electrical barrier was not sufficiently high due to a low copper peak in the intermediate regions.

Aspects in the present disclosure are, for example, as follows.

<1>A multilayer ceramic electronic component, including:
a plurality of dielectric layers laminated along a first axis;
a plurality of internal electrode layers each positioned between those of the dielectric layers that adjoin each other along the first axis; and
intermediate regions positioned between the dielectric layers and the internal electrode layers,
wherein the internal electrode layers contain a nickel-copper alloy,
the intermediate regions contain copper,
a concentration of the copper in the intermediate regions has a peak at 2 at % or greater and 10 at % or less,
the intermediate regions partially contain an NiO layer on the internal electrode layers, and
a total area of the NiO layer relative to a total area of the internal electrode layers in a cross-section of the multilayer ceramic electronic component is 1% or greater and 3.5% or less.
   <2> The multilayer ceramic electronic component according to <1>,
wherein the intermediate regions contain a copper-segregated layer on the internal electrode layers.
   <3> The multilayer ceramic electronic component according to <2>,
wherein the NiO layer is provided in a region where the copper-segregated layer is not provided.
   <4> The multilayer ceramic electronic component according to any of <1> to <3>,
wherein the nickel-copper alloy contains 0.2 at % or greater and 5 at % or less of copper.
   <5> The multilayer ceramic electronic component according to any of <1> to <4>,
wherein the concentration of the copper in the intermediate regions is measured by energy dispersive X-ray spectroscopy using a transmission electron microscope.

In this disclosure, in some embodiments, the material/composition constituting dielectric layers, internal electrode layers, and intermediate regions may consist of required/explicitly indicated elements described in the present disclosure; however, “consisting of” does not exclude additional components that are known equivalents to the elements and/or unrelated components such as impurities ordinarily associated with the elements. Also, in some embodiments, the term “main component” refers to “primary, majority, or predominant component in terms of quantity or quality, and the term “mainly composed of” refers to “primarily, mostly, or predominantly composed of” in terms of quantity or quality. Further, in some embodiments which are silent as to known components used in this technology field, the known components can explicitly be excluded from the embodiments. Also, in some embodiments, any two numbers of a variable can constitute a workable range of the variable as the workable range can be determined based on routine work, and any ranges indicated may include or exclude the endpoints. Additionally, any values of variables indicated (regardless of whether or not they are indicated with “about”) refer to precise values or may approximate/rounded values and include equivalents, and may refer to average, median, representative, majority, etc. in some embodiments. In this disclosure, “a” may refer to a species or a genus including multiple species, while a plural may not exclude singular according to the context. Further, “the disclosure” or “the present disclosure” may refer collectively to at least one of the embodiments or examples explicitly or inherently disclosed herein. Also, in some embodiments, any one or more of the disclosed elements or components as options can be exclusively selected or can expressly be excluded, depending on the target piezoelectric ceramic to be manufactured, its target properties, etc., and/or for practical reasons, operational reasons, etc. Additionally, the in present disclosure where conditions and/or structures are not specified, a skilled artisan in the art can readily provide such conditions and/or structures, in view of the present disclosure, as a matter of routine experimentation, etc.

What is claimed is:

1. A multilayer ceramic electronic component, comprising:
a plurality of dielectric layers laminated along a first axis;
a plurality of internal electrode layers each positioned between adjacent dielectric layers in the first axis of the plurality of dielectric layers; and
intermediate regions positioned between the dielectric layers and the internal electrode layers, respectively,
wherein the internal electrode layers contain a nickel-copper alloy,
the intermediate regions contain copper,
a concentration of the copper in each intermediate region varies in a thickness direction and has a peak at 2 at % or greater and 10 at % or less,
the intermediate regions partially contain NiO layers at boundaries with the internal electrode layers, and
a total area of the NiO layers relative to a total area of the internal electrode layers is 1% or greater and 3.5% or less as measured on a cross-section of the multilayer ceramic electronic component along the first axis.

2. The multilayer ceramic electronic component according to claim 1,
wherein the intermediate regions contain copper-segregated layers at boundaries with the internal electrode layers.

3. The multilayer ceramic electronic component according to claim 2,
wherein the NiO layers are provided in a region at boundaries with the internal electrode layers where the copper-segregated layers are not provided.

4. The multilayer ceramic electronic component according to claim 1,
wherein the nickel-copper alloy contains 0.2 at % or greater and 5 at % or less of copper.

5. The multilayer ceramic electronic component according to claim 1,
wherein the concentration of the copper in the intermediate regions is measured by energy dispersive X-ray spectroscopy using a transmission electron microscope.
